(19) United States
(12) Patent Application Publication
(10) Pub. No.: US 2026/0296210 A1
(43) Pub. Date: Oct. 1, 2026

(54) Electric Vehicle and Method of Controlling Thereof

(71) Applicant: POLITECNICO DI TORINO, Torino (TO) (IT)

(72) Inventors: Massimiliana Carello, Torino (IT); Henrique De Carvalho Pinheiro, Torino (IT); Giovanni Imberti, San Benigno Canavese (IT); Giuseppe Pio Tempone, Calvello (IT)

(21) Appl. No.: 19/479,789

(22) PCT Filed: Apr. 16, 2024
(86) PCT No.: PCT/IB2024/053694

§ 371 Date: Oct. 29, 2025

(30) Foreign Application Priority Data
May 4, 2023 (IT) 102023000008907

(51) Int. Cl. B60L 7/18; B60L 7/26; B60L 50/60

(52) U.S. Cl. CPC B60L 7/18; B60L 7/26; B60L 50/60; B60L 2240/425; B60L 2240/461; B60L 2240/463; B60L 2240/545

(57) ABSTRACT

An electric vehicle includes: a wheel; an electric motor connected to the wheel, the electric motor being configured to provide regenerative braking; an electrically actuated brake connected to the wheel to exert a second braking action; at least one storage device electrically connected to the electric motor and to the electrically actuated brake in order to supply power thereto and receive energy; at least one control unit. The storage device includes a sensor detecting a physical condition of the storage device. The at least one control unit is configured for: receiving from the sensor a value related to said the physical condition of the storage device; comparing the value with a predetermined threshold stored in memory of the control unit; inhibiting the flow of electric current generated by the regenerative braking towards the storage device, and allowing the flow of said electric current towards the electrically actuated brake.

### BACKGROUND OF THE DISCLOSURE

### 1. The Field of the Disclosure

The present invention relates to an electric vehicle.

### 2. The Relevant Technology

It is known in the art that one of the most demanding and interesting challenges in the world of modern vehicles is to lower the vehicles' emissions of carbon dioxide (CO₂), nitrogen oxides (NOₓ), and particulate matter. In this regard, the introduction of electric vehicles on the market aims at eliminating or greatly reducing the local emissions of internal combustion engines.

An electric vehicle is a means of transport using an electric propulsion system typically powered by an energy storage device, e.g., at least one rechargeable battery; depending on specific requirements or design features, electric vehicles may have one, two, three, four or more wheels.

In this respect, it should be noted that, according to the present invention, the term “electric vehicle” also refers to the so-called “hybrid” vehicles, i.e., vehicles having a propulsion system consisting of two components operating synergically, said two components comprising, in particular, at least one electric motor and at least one internal combustion engine (or vehicles comprising a fuel-cell system).

Cars, motorcycles, buses, vans, bicycles, unicycles, etc. are the most common and most widespread electric vehicles. Electric vehicles have now been in use for quite a long time, and are currently available for all types of transport applications.

It is known in the art that electric vehicles include at least one electric motor for driving the vehicle and for providing a regenerative braking function, i.e. the electric motor can operate in two directions:
forwards: when an accelerator control of the vehicle is operated (e.g., when an accelerator pedal is pressed or an accelerator grip is turned), the motor performs a driving function and moves at least one wheel associated therewith;
backwards: when the accelerator control is released and the brake is operated (in particular, when a braking control of the vehicle is operated, e.g., when a brake pedal is pressed or a brake lever is pulled), the electric motor operates in reverse mode and generates electric energy, which is used to recharge at least one energy storage device, e.g., at least one rechargeable battery.

Basically, when braking a vehicle, an electric motor provides a braking contribution consisting of a resistant force directly applied to the transmission unit by the electric motor, which, being mechanically connected to at least one wheel (e.g., through an axle shaft) acts as a motor generator.

The electric vehicles known in the art suffer from a few drawbacks.

In conditions of high state of charge (SoC) of the electric storage device (usually consisting of a rechargeable battery), regenerative braking is less effective because the energy storage system cannot transform and absorb, in the form of electric energy, the kinetic energy recovered by the electric motor. This results in a reduction in the efficiency of the regenerative system and a reduction in the overall energetic efficiency of the vehicle.

Some attempts have been made to solve this problem by increasing the use of the braking system. As an alternative, some solutions have proposed to dissipate by means of resistors the energy recovered by regenerative braking. However, such solutions cannot maximize the regenerative braking effects when the state of charge (SoC) of the storage device is too high to provide sufficient regeneration, nor can they safeguard the storage device to ensure a long life of the same or protect it when it overheats.

It is therefore apparent that, in the electric vehicles currently known in the art, regenerative braking represents a stress factor for the storage device, in particular such stress factor being due to a continual succession of charge and discharge sessions resulting, as a short-term effect, in increased temperature of the battery pack and, as a long-term effect, in faster ageing or deterioration of the storage device.

The electric vehicles known in the art are equipped with braking systems combined with a regenerative braking function, and this could permit a potential reduction in the dimensions of the brake units due to the contribution of the regenerative braking function. In the electric vehicles known in the art, however, the dimensions of the braking system have remained unchanged because of specific cooling requirements of the braking system itself, which needs to absorb the energy that is dissipated as heat during the braking action. As a consequence, the electric vehicles currently known in the art have oversized braking systems, and such oversizing results in a number of problems, such as higher costs incurred for manufacturing the components and heavier brake units, all of which reduce the efficiency of the system as a whole. In addition, efficiency is further reduced when a battery cooling system is implemented, i.e., solutions designed to maintain the storage system within certain operating limits.

A further drawback of the electric vehicles currently known in the art lies in the fact that, in electric vehicles equipped with a front axle and a rear axle, distribution of the braking action between such axles occurs by means of a brake modulator (EBD), which keeps the vehicle in safe driving conditions. When braking, in fact, the load is not the same on all wheels, since the rear axle becomes unloaded and tends to lock. Although the latest braking systems feature an adjustable brake-force distribution system, providing an efficient regulation of the braking action approaching optimal brake-force distribution (i.e., a distribution ensuring that locking will not occur on one axle only), it is nevertheless impossible to obtain an ideal brake-force distribution curve by means of a traditional hydraulic braking system.

### SUMMARY OF T HE DISCLOSURE

In this frame, it is the main object of the present invention to provide an electric vehicle which is adapted to overcome the drawbacks of prior-art electric vehicles.

In particular, it is one object of the present invention to provide an electric vehicle so conceived as to avoid a reduction in the efficiency of the regenerative system and a reduction in the energetic efficiency of the vehicle as a whole, in particular the electric vehicle according to the invention maximizing the regenerative braking effects when the state of charge (SoC) of the storage device is too high to provide sufficient regeneration, and safeguarding the conditions of the storage device to ensure a long life of the same, while also protecting it when it overheats.

It is another object of the present invention to provide an electric vehicle so conceived as to avoid that regenerative braking might represent a stress factor for the storage device, in particular for the purpose of preventing an increase in the temperature of the battery pack and faster ageing of the storage device.

It is a further object of the present invention to provide an electric vehicle so conceived as to allow reducing the size of the braking system, thus reducing the production costs of the components and the mass of the brake unit, and consequently increasing the global efficiency of the system.

It is yet another object of the present invention to provide an electric vehicle so conceived as to provide adequate brake-force distribution between the axles comprised in said electric vehicle, resulting in an ideal distribution curve.

### BRIEF DESCRIPTION OF THE DRAWINGS

Further objects, features and advantages of the present invention will become apparent in light of the following detailed description and of the annexed drawings, which are provided herein merely by way of non-limiting explanatory example, wherein:

FIG. 1 is a schematic view of a first embodiment of an electric vehicle according to the present invention;

FIG. 2 is a schematic view of a second embodiment of an electric vehicle according to the present invention;

FIG. 3 is a schematic view of a third embodiment of an electric vehicle according to the present invention.

### DETAILED DESCRIPTION OF THE PREFERRED EMBODIMENTS

Referring now to the annexed drawings, reference numeral 1 designates as a whole an electric vehicle according to the present invention.

The electric vehicle 1 comprises at least one wheel 10 and one electric motor 20 mechanically connected to said at least one wheel 10 in order to drive said at least one wheel 10 (and hence the electric vehicle 1), wherein said electric motor 20 is configured to provide regenerative braking, which exerts a first braking action on said at least one wheel 10. Since the mechanical connection between the wheel 10 and the electric motor 20 can be implemented in many ways known in the art, it will not be described in detail herein.

As already explained above, the term “electric vehicle” is used herein to refer also to the so-called “hybrid” vehicles; therefore, the electric vehicle 1 according to the present invention may also be equipped with an additional propulsion system (e.g., an internal combustion engine) operating in synergy with said electric motor 20.

The electric vehicle 1 further comprises an electrically actuated brake 30 mechanically connected to said at least one wheel 10 in order to exert a second braking action on said at least one wheel 10.

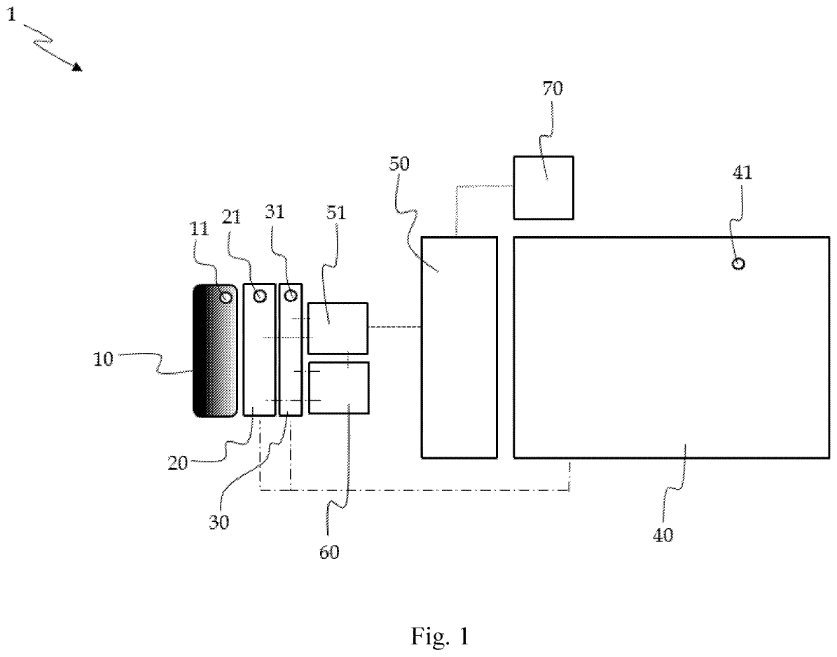

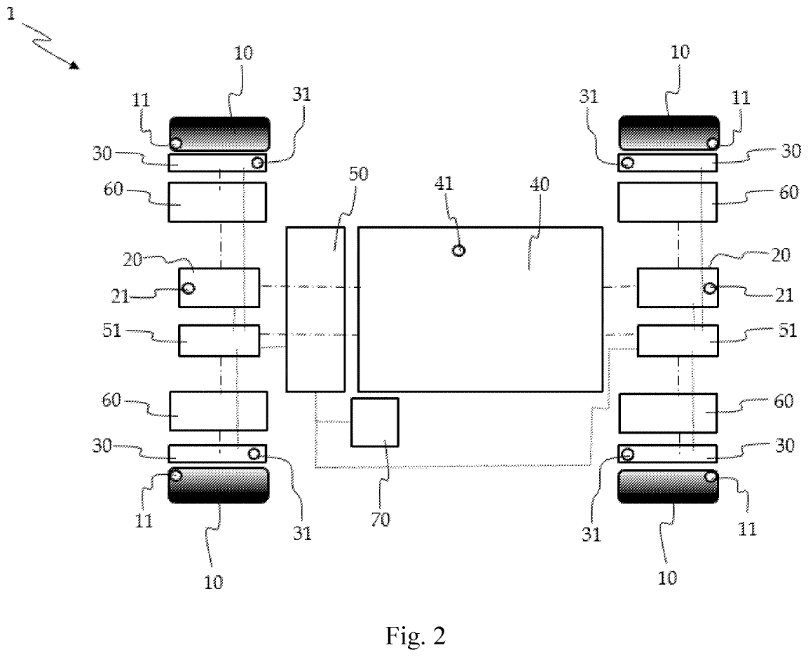

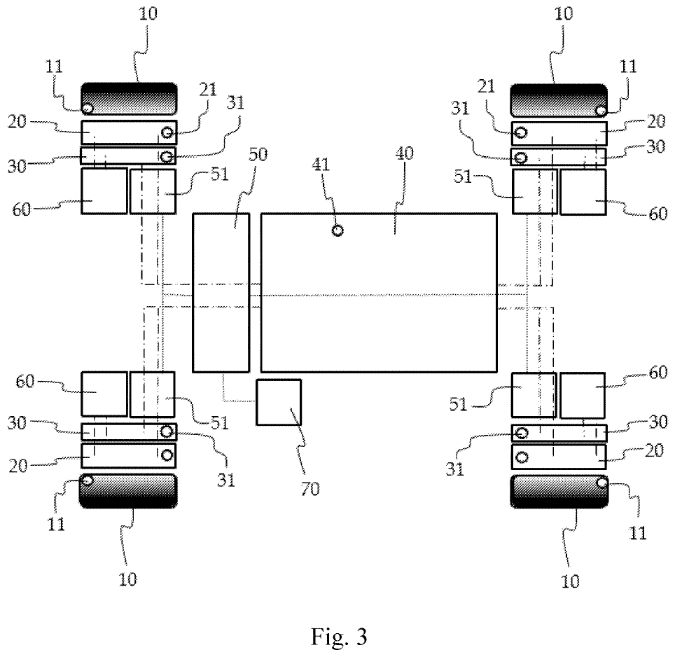

In the first embodiment shown in FIG. 1, the electric vehicle 1 comprises a single wheel 10 (therefore, the electric vehicle 1 is a unicycle), whereas in the second and third embodiments (respectively shown in FIG. 2 and FIG. 3) the electric vehicle 1 comprises a plurality of wheels 10. In this regard, it should be noted that, in all embodiments shown in the accompanying drawings, the electric vehicle 1 comprises at least one electric motor 20 mechanically connected to a wheel 10; in particular, in the embodiments of FIGS. 1 and 3 said electric vehicle 1 comprises one electric motor 20 per wheel 10 (i.e., the electric vehicle 1 shown in FIGS. 1 and 3 has a 1:1 ratio between the wheels 10 and the respective electric motors 20), while in the embodiment of FIG. 2 the electric vehicle 1 comprises one common electric motor 10 for two wheels 10 positioned on one same axle (not shown in the annexed drawings) of the electric vehicle 1 (i.e., the electric vehicle 1 shown in FIG. 2 has a 2:1 ratio between the wheels 10 and the respective electric motors 20, wherein the wheels 10 are connected to one same electric motor 20 through one same axle of the electric vehicle 1).

By way of example, in the embodiments illustrated in FIGS. 1 and 3 the electric motors 20 may be of the type known as “in-wheel” motors (also referred to as “in-hub” motors), i.e., the type suitable for installation in the hub of the wheel 10 to drive said wheel 10.

In addition, in all embodiments shown in the accompanying drawings the electric vehicle 1 comprises an electrically actuated brake 30 for each respective wheel 10; essentially, in all of said embodiments the electric vehicle 1 has a 1:1 ratio between the wheels 10 and the respective electrically actuated brakes 30.

The electric vehicle 1 further comprises at least one storage device 40 electrically connected to said electric motor 20 and to said electrically actuated brake 30 in order to supply power thereto and receive energy, in the form of electric current, from said regenerative braking of the electric motor 20. Preferably, said storage device 40 comprises at least one battery, in particular a rechargeable battery.

In accordance with the present invention, said storage device 40 comprises sensor means 41 adapted to detect at least one physical condition of said storage device 40, in particular a state of charge and/or the temperature of said storage device 40.

Furthermore, the vehicle 1 comprises at least one control unit 50, 51 configured for:
receiving from said sensor means 41 at least one value related to said at least one physical condition of the storage device 40;
comparing said at least one value with a predetermined threshold stored in memory means (not shown in the accompanying drawings) of said at least one control unit 50, 51;
inhibiting the flow of electric current generated by said regenerative braking towards the storage device 40 if said at least one value is above said predetermined threshold, and (substantially at the same time or simultaneously)
allowing the flow of said electric current towards the electrically actuated brake 30.

In particular, said sensor means 41 may comprise a state-of-charge sensor and/or a temperature sensor of the storage device 40; therefore, said at least one value is related to the state of charge and/or the temperature of the storage device 40.

In this regard, it should be noted that the electric connection among the various components of the electric vehicle 1 is shown in the annexed drawings by means of dashed-dotted lines, while the connections providing control over the various components of said electric vehicles 1 and signal transfer among said components are shown by means of dotted lines. In this respect, it must be pointed out that said control and signal transfer connections may be either wired or wireless. For example, the various components of the electric vehicle 1 according to the present invention may be designed to comprise known communication means, e.g., said communication means comprising at least one of the following interfaces: a WiFi interface, a Bluetooth interface, a GSM interface, an LTE interface, a 5G interface, a CANBUS interface, an Ethernet interface, etc.

In one embodiment, said at least one control unit 50, 51 comprises a central control unit 50 and at least one peripheral control unit 51, wherein said central control unit 50 is configured to send to said at least peripheral control unit 51 control signals concerning the operation of the electric motor 20 and of the electrically actuated brake 30 connected to said at least one wheel 10, wherein said at least one peripheral control unit 51 is configured to transmit said control signal to the electric motor 20 and to the electrically actuated brake 30 in order for the execution of said control signals, and wherein said at least one peripheral control unit 51 is configured to re-share data with the central control unit 50. Essentially, said central control unit 50 is configured to send and receive control signals, while said at least one peripheral control unit 51 is configured to transmit power to execute the control signals coming from the central control unit 50.

In this regard, it should be noted that this embodiment is to be preferred especially when the electric vehicle 1 comprises a plurality of wheels 10 (as in the embodiments shown in FIGS. 2 and 3); in such a case, in fact, with each wheel 10 a peripheral control unit 51 is associated, which is configured to transmit control signals (coming from the central control unit 50) to the electric motor 20 and to the electrically actuated brake 30 connected to that wheel 10.

The electric vehicle 1 according to the present invention further comprises management means (represented as a whole as a block identified by reference numeral 60 in the accompanying drawings) comprising at least one converter and/or at least one breaker and/or at least one switch associated with each assembly consisting of an electric motor 20 and a respective electrically actuated brake 30, said management means 60 being configured to modulate the power coming from the storage device 40 and manage the electric current between the electric motor 20 and the electrically actuated brake 30.

It is therefore clear that, in such a braking state or configuration (which can be defined as “Disconnected” in that the storage device 40 is electrically insulated from the assembly consisting of the electric motor 20 and the electrically actuated brake 30), the braking torque of the electric vehicle 1 will be generated by combining the regenerative braking action of the electric motor 20 with the action of the electrically actuated brake 30, so that said regenerative braking will generate an amount of electric current sufficient to activate the electrically actuated brake 30 in order to cumulatively obtain the optimal torque necessary for fulfilling the request issued by said at least one central control unit 50, 51, in particular said central control unit 50, 51 reacting, in turn, to a request issued upon actuation and/or release of control means 70 (e.g., the actuation of a braking control and/or the release of an accelerator control) by a user of the electric vehicle 1.

It is therefore apparent that, in the “Disconnected” configuration, the storage device 40 will remain neutral towards the deceleration manoeuvres of the wheel 10 (and hence of the electric vehicle 1), and regeneration can be maximized during all those driving phases in which the energy storage system would strongly limit the energy recovery performance, by supplying electric current obtained by regenerative braking directly to the electrically actuated brake 30.

Said “Disconnected” configuration makes it possible to attain a level of energy optimization and component protection much higher than according to other logics known in the art, which are usually based on series or parallel braking control systems that, after recovering kinetic deceleration energy from an electric motor, transfer the same to the battery in the form of electric energy.

It is clear that, when said at least one value detected by the sensor means 41, related to said at least one physical condition of the storage device 40, is lower than said predetermined threshold (i.e., when the state of charge and/or the temperature of the storage device 40 are below a predetermined critical threshold), said at least one control unit 50, 51 is configured to allow the electric current generated by said regenerative braking to flow towards the storage device 40. In this configuration (which can be defined as “Baseline” configuration), said at least one control unit 50, 51 permits the use of the entire braking capacity of the regenerative braking function of the electric motor 20, so as to recover as much kinetic energy as possible. If the regenerative braking of the electric motor 20 is insufficient to provide the requested torque, said at least one control unit 50, 51 is configured to request the electrically actuated brake 30 to provide the difference between the maximum regenerative braking force of the electric motor 20 and the demanded torque; in this manner, the storage device 40 will receive a net charge equal to the difference between the current obtained from the regenerative braking function of the electric motor 20 and the current required by the electrically actuated brake 30.

In one embodiment, the electric vehicle 1 comprises at least one temperature sensor 21 associated with the electric motor 20, wherein said at least one control unit 50, 51 is configured for:
receiving from said temperature sensor 21 at least one temperature value of the electric motor 20;
comparing said at least one temperature value of the electric motor 20 with a predetermined temperature threshold stored in the memory means of said at least one control unit 50, 51;
deactivating the regenerative braking of the electric motor 20 if said at least one temperature value of the electric motor 20 is above said predetermined temperature threshold, and (substantially at the same time or simultaneously)
requesting that the necessary braking torque be provided, in particular in a substantially exclusive manner, by the electrically actuated brake 30.

This configuration, which can be defined as “Full Braking” configuration, and wherein the storage device 40 is in discharge-only mode and cannot use the regenerative braking of the electric motor 20, makes it possible to lower the temperature of the electric motor 20, thus preventing it from overheating. It is therefore apparent that the “Full Braking” configuration is useful to safeguard the electric motor 20, preventing it from ageing or deteriorating quickly.

It is clear that, when said at least one temperature value detected by the temperature sensor 21, concerning the temperature of the electric motor 20, is lower than said predetermined temperature threshold (i.e., when the temperature of the electric motor 20 is at or below a predetermined temperature threshold considered to be critical), said at least one control unit 50, 51 is configured to request that the necessary braking torque be provided by both the regenerative braking function of the electric motor 20 and the electrically actuated brake 30.

In one embodiment, the electric vehicle 1 comprises at least one further temperature sensor 31 associated with the electrically actuated brake 30, wherein said at least one control unit 50, 51 is configured for:
receiving from said at least one further temperature sensor 31 at least one further temperature value of the electrically actuated brake 30;
comparing said at least one further temperature value with a further predetermined temperature threshold stored in the memory means of said at least one control unit 50, 51;
deactivating the braking of the electrically actuated brake 30 if said at least one further temperature value is above said further predetermined temperature threshold, and (substantially at the same time or simultaneously)
requesting that the necessary braking torque be provided, in particular in a substantially exclusive manner, by the regenerative braking of the electric motor 20.

This configuration, which can be defined as “Full Regenerative”, makes it possible to lower the temperature of the electrically actuated brake 30, thus preventing it from overheating. It is therefore apparent that also the “Full Regenerative” configuration permits safeguarding a component of the electric vehicle 1, i.e., the electrically actuated brake 30, preventing it from ageing or deteriorating quickly.

Furthermore, thanks to the provision of the “Full Regenerative” configuration, it is possible to avoid oversizing the electrically actuated brake 30, since such oversizing was necessary in prior-art vehicles to meet specific cooling needs of the braking system. It is therefore apparent that the provisions of the present invention make it possible to reduce the costs and masses of components of the electric vehicle 1, thereby increasing the global efficiency of the system.

It is clear that, when said at least one further temperature value detected by said further temperature sensor 31, concerning the temperature of the electrically actuated brake 30, is lower than said further predetermined temperature threshold (i.e., when the temperature of the electrically actuated brake 30 is at or below a predetermined threshold considered to be critical), said at least one control unit 50, 51 is configured to request that the necessary braking torque be provided by both the regenerative braking function of the electric motor 20 and the electrically actuated brake 30.

In accordance with the present invention, the electric vehicle 1 may also comprise at least one sensor 11 associated with the wheel 10 and adapted to detect at least one dynamic condition of said wheel 10, in particular a vertical force acting upon the wheel 10 and/or an angular velocity of said wheel 10.

In this context, said at least one control unit 50, 51 is configured for:
receiving from said at least one sensor 11 at least one value related to said at least one dynamic condition of the wheel 10;
comparing said at least one value with a predetermined ideal value stored in memory means (not shown in the accompanying drawings) of said at least one control unit 50, 51;
controlling the electric motor 20 and/or an optional anti-lock braking system (ABS, not shown in the accompanying drawings) and/or an optional electronic stability control system (ESC, not shown in the accompanying drawings) of the electric vehicle 1 in such a way as to bring said value related to said at least one dynamic condition of the wheel 10 back to said predetermined ideal value (i.e., to bring the wheel 10 back into a stable condition).

The following will describe a method of controlling the electric vehicle 1 according to the present invention, wherein said method comprises the following steps, managed by at least one control unit 50, 51 (in accordance with a configuration that can be defined as “Disconnected” configuration) of said electric vehicle 1:
receiving, from sensor means 41 associated with the storage device 40, at least one value related to at least one physical condition, in particular a state of charge and/or the temperature, of said storage device 40;
comparing said at least one value with a predetermined threshold stored in memory means (not shown in the accompanying drawings) of said at least one control unit 50, 51;
inhibiting the flow of electric current generated by said regenerative braking towards the storage device 40 if said at least one value is above said predetermined threshold, and (substantially at the same time or simultaneously)
allowing the flow of said electric current generated by said regenerative braking towards the electrically actuated brake 30.

In one embodiment, the control method according to the present invention may further comprise the following steps, still managed by said at least one control unit 50, 51 (in accordance with a configuration that can be defined as “Full Braking” configuration):
receiving, from at least one temperature sensor 21 associated with the electric motor 20, at least one temperature value of said electric motor 20;
comparing said at least one temperature value with a predetermined temperature threshold stored in the memory means of said at least one control unit 50, 51;
deactivating the regenerative braking of the electric motor 20 if said at least one temperature value is above said predetermined temperature threshold, and (substantially at the same time or simultaneously)
requesting that the necessary braking torque be provided, in particular in a substantially exclusive manner, by the electrically actuated brake 30.

In one embodiment, the control method according to the present invention may further comprise the following steps, still managed by said at least one control unit 50, 51 (in accordance with a configuration that can be defined as “Full Regenerative” configuration):
receiving from a further temperature sensor 31 associated with the electrically actuated brake 30 at least one further temperature value of said electrically actuated brake 30;
comparing said at least one further temperature value with a further predetermined temperature threshold stored in the memory means of said at least one control unit 50, 51
deactivating the braking of the electrically actuated brake 30 if said at least one further temperature value is above said further predetermined temperature threshold, and (substantially at the same time or simultaneously)
requesting that the necessary braking torque be provided, in particular in a substantially exclusive manner, by the regenerative braking of the electric motor 20.

In one embodiment, the control method according to the present invention may further comprise the following steps, still managed by said at least one control unit 50, 51:
detecting at least one value related to at least one dynamic condition of at least one wheel 10 by means of at least one sensor 11 associated with said at least one wheel 10;
comparing said at least one value with a predetermined ideal value stored in memory means of said at least one control unit 50, 51;
controlling the electric motor 20 and/or an optional anti-lock braking system of the electric vehicle 1 and/or an optional electronic stability control system of the electric vehicle 1 in such a way as to bring said value related to said at least one dynamic condition of the wheel 10 back to said predetermined ideal value.

It must be pointed out that, especially when the electric vehicle 1 comprises a plurality of wheels 10 (and a plurality of electric motors 20 and electrically actuated brakes 30), the above-described steps of the method are preferably managed by a central control unit 50 and at least one peripheral control unit 51, wherein the central control unit 50 sends control signals concerning the operation of each electric motor 20 and each electrically actuated brake 30 connected to each wheel 10, and wherein said at least one peripheral control unit 51 transmits said control signals to the electric motor 20 and to the electrically actuated brake 30, and wherein said at least one peripheral control unit 51 re-shares data with the central control unit 50.

The features of the electric vehicle 1 and of the related control method according to the present invention, as well as the advantages thereof, are apparent from the above description.

As a matter of fact, the provisions of the present invention make it possible to overcome the drawbacks of prior-art electric vehicles by providing an electric vehicle 1 so conceived as to avoid a reduction in the efficiency of the regenerative system and a reduction in the global energetic efficiency of said electric vehicle 1, in particular the electric vehicle 1 according to the present invention being able to maximize the regenerative braking effects when the state of charge (SoC) of the storage device 40 is too high to provide sufficient regeneration, while also safeguarding the conditions of the storage device 40 to ensure a long life of the same and protecting it when it overheats.

As a consequence, another advantage of the solution according to the present invention lies in the fact that the electric vehicle 1 is designed to avoid that regenerative braking might represent a stress factor for the storage device 40, in particular for the purpose of preventing an increase in the temperature of said storage device 40 resulting in faster ageing of the same.

A further advantage of the electric vehicle 1 according to the present invention lies in the fact that it provides adequate brake-force distribution between a regenerative braking action of the electric motor 20 and the action of the electrically actuated brake 30 according to conditions, in particular temperature values, of such components, disabling either brake type depending on the temperature of the electric motor 20 and of the electrically actuated brake 30. It is therefore apparent that the electric vehicle 1 can appropriately distribute the brake force between the axles comprised in said electric vehicle 1 to obtain, as a result, an ideal distribution curve.

The provisions of the present invention also allow for controlling the electric motor 20 and/or an optional anti-lock braking system (ABS) and/or an optional electronic stability control system (ESC) to bring a value concerning at least one dynamic condition of the wheel 10 back to a predetermined ideal value (i.e., to bring the wheel 10 back into a stable condition).

The electric vehicle 10 and the related control method described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described electric vehicle 1 and related control method, but may be subject to many modifications, improvements or replacements of equivalent parts and elements without departing from the inventive idea, as clearly specified in the following claims.

1. An electric vehicle comprising:
at least one wheel;
an electric motor mechanically connected to said at least one wheel in order to drive said at least one wheel, wherein said electric motor is configured to provide regenerative braking, which exerts a first braking action on said at least one wheel
an electrically actuated brake mechanically connected to said at least one wheel in order to exert a second braking action on said at least one wheel;
at least one storage device electrically connected to said electric motor and to said electrically actuated brake in order to supply power thereto and receive energy, in the form of electric current, from said regenerative braking of the electric motor
at least one control unit
wherein said storage device comprises a sensor adapted to detect at least one physical condition of said storage device, in particular a state of charge and/or the temperature of said storage device,
wherein said at least one control unit is configured for:
receiving from said sensor at least one value related to said at least one physical condition of the storage device;
comparing said at least one value with a predetermined threshold stored in memory of said at least one control unit,
inhibiting the flow of electric current generated by said regenerative braking towards the storage device if said at least one value is above said predetermined threshold, and
allowing the flow of said electric current towards the electrically actuated brake

2. The electric vehicle according to claim 1, wherein said sensor comprises a state-of-charge sensor and/or a temperature sensor of the storage device and said at least one value is related to the state of charge and/or the temperature of the storage device

3. The electric vehicle according to claim 1, wherein at least one control unit comprises a central control unit and at least one peripheral control unit,
wherein said central control unit is configured to send to said at least one peripheral control unit control signals concerning the operation of the electric motor and of the electrically actuated brake connected to said at least one wheel,
wherein said at least one peripheral control unit is configured to transmit said control signals to the electric motor and to the electrically actuated brake for the execution of said control signals,
and wherein said at least one peripheral control unit is configured to re-share data with the central control unit.

4. The electric vehicle according to one claim 1, further comprising management means comprising at least one converter and/or at least one breaker and/or at least one switch associated with each assembly consisting of an electric motor and a respective electrically actuated brake wherein said management means are configured to modulate the power coming from the storage device and manage the electric current between the electric motor and the electrically actuated brake.

5. The electric vehicle according to claim 1, further comprising at least one temperature sensor associated with the electric motor, wherein said at least one control unit is configured for:
receiving from said temperature sensor at least one temperature value of the electric motor;
comparing said at least one temperature value of the electric motor with a predetermined temperature threshold stored in the memory of said at least one control unit
deactivating the regenerative braking of the electric motor if said at least one temperature value is above said predetermined temperature threshold; and
requesting that the necessary braking torque be provided by the electrically actuated brake.

6. The electric vehicle according to claim 1, comprising at least one further temperature sensor associated with the electrically actuated brake
wherein said at least one control unit is configured for:
receiving from said at least one further temperature sensor at least one further temperature value of the electrically actuated brake;
comparing said at least one further temperature value with a further predetermined temperature threshold stored in the memory of said at least one control unit;
deactivating the braking of the electrically actuated brake if said at least one further temperature value is above said further predetermined temperature threshold, and
requesting that the necessary braking torque be provided by the regenerative braking of the electric motor.

7. The electric vehicle according to claim 1, further comprising at least one sensor associated with the wheel and adapted to detect at least one dynamic condition of said wheel,
wherein said at least one control unit is configured for:
receiving from said at least one sensor at least one value related to said at least one dynamic condition of the wheel;
comparing said at least one value with a predetermined ideal value stored in memory of said at least one control unit;
controlling the electric motor and/or an anti-lock braking system of the electric vehicle and/or an optional electronic stability control system of the electric vehicle in such a way as to bring said value related to said at least one dynamic condition of the wheel back to said predetermined ideal value.

8. A method of controlling an electric vehicle comprising:
at least one wheel;
an electric motor mechanically connected to said at least one wheel in order to drive said at least one wheel, wherein said electric motor is configured to provide regenerative braking, which exerts a first braking action on said at least one wheel;
an electrically actuated brake mechanically connected to said at least one wheel in order to exert a second braking action on said at least one wheel;
at least one storage device electrically connected to said electric motor and to said electrically actuated brake in order to supply power thereto and receive energy, in the form of electric current, from said regenerative braking of the electric motor;
at least one control unit
said method comprising the following steps, managed by said at least one control unit:
receiving, from a sensor associated with the storage device at least one value related to at least one physical condition, in particular a state of charge and/or the temperature, of said storage device;
comparing said at least one value with a predetermined threshold stored in memory of said at least one control unit;
inhibiting the flow of electric current generated by said regenerative braking towards the storage device if said at least one value is above said predetermined threshold; and
allowing the flow of said electric current generated by said regenerative braking towards the electrically actuated brake.

9. The method according to claim 8, further comprising the following steps, managed by said at least one control unit
receiving, from at least one temperature sensor associated with the electric motor, at least one temperature value of said electric motor;
comparing said at least one temperature value with a predetermined temperature threshold stored in the memory of said at least one control unit
deactivating the regenerative braking of the electric motor if said at least one temperature value is above said predetermined temperature threshold; and
requesting that the necessary braking torque be provided, by the electrically actuated brake.

10. The method according to claim 8, further comprising the following steps, managed by said at least one control unit:
receiving, from a further temperature sensor associated with the electrically actuated brake, at least one further temperature value of said electrically actuated brake;
comparing said at least one further temperature value with a further predetermined temperature threshold stored in the memory of said at least one control unit;
deactivating the braking of the electrically actuated brake if said at least one further temperature value is above said further predetermined temperature threshold, and
requesting that the necessary braking torque be provided by the regenerative braking of the electric motor.

11. The method according to comprisesclaim 8, further comprising the following steps, managed by said at least one control unit:
detecting at least one value related to at least one dynamic condition of at least one wheel by at least one sensor associated with said at least one wheel;
comparing said at least one value with a predetermined ideal value stored in memory of said at least one control unit;
controlling the electric motor and/or an optional anti-lock system of the electric vehicle and/or an optional electronic stability control system of the electric vehicle in such a way as to bring said at least one value related to said at least one dynamic condition of the wheel back to said predetermined ideal value.

12. The method according claim 8, wherein said steps are managed by a central control unit and at least one peripheral control unit,
wherein the central control unit sends control signals concerning the operation of each electric motor and each electrically actuated brake connected to a wheel
wherein said at least one peripheral control unit transmits said control signals to the electric motor and to the electrically actuated brake connected to a wheel,
and wherein said at least one peripheral control unit re-shares data with the central control unit.
